(19) United States
(12) Patent Application Publication
(10) Pub. No.: US 2014/0122297 A1
(43) Pub. Date: May 1, 2014

(54) SYSTEM AND METHOD FOR MESSAGE TETHERING AND TAGGING

(71) Applicant: Autobytel Inc., Irvine, CA (US)

(72) Inventors: Bret J. DUNLAP, Villanova, PA (US); Eric C. Deininger, Chester Springs, PA (US); David G. Sawyer, Dripping Springs, TX (US)

(73) Assignee: Autobytel Inc., Irvine, CA (US)

(21) Appl. No.: 14/068,955

(22) Filed: Oct. 31, 2013

Related U.S. Application Data
(60) Provisional application No. 61/720,561, filed on Oct. 31, 2012.

(51) Int. Cl. G06Q 30/06; H04W 4/12

(52) U.S. Cl. CPC G06Q 30/0623; H04W 4/12
USPC 705/26.61

(57) ABSTRACT

A tethering and tagging system is especially advantageous for automobile sales. Tethering provides the seller with the portable means to text message a consumer from a mobile device while keeping an ongoing record within the main system. The tagging element provides the seller with detailed information about the product for which the end-user has an interest. This is done through a direct database query and does not require the end-user to enter or select the product on a web page (or mobile web page) form.

### RELATED APPLICATION

The present application claims the benefit of U.S. Provisional Application No. 61/720,561, filed Oct. 31, 2012, the entire contents of which are incorporated herein by reference.

### FIELD OF THE INVENTION

The present invention relates to message tethering and tagging. More specifically, the present invention relates to a system and method of bi-directional conversation between a desktop interface and a mobile SMS messaging application.

### BACKGROUND OF THE INVENTION

When faced with a relatively large purchase, particularly a durable goods purchase, consumers tend to research their options in the marketplace with more diligence than for smaller purchases. Traditionally, this has been done through voice communications with a sales person, either face-to-face or through the telephone. The Internet revolution has provided consumers with great amounts of easily accessible information as well as a level of anonymity, which is often a consumer's preference as they seek to gather information before a buying decision is made. Consumers are now armed with more portable mobile devices that can access the Internet while away from the traditional desktop computer. Mobile computing has greatly enhanced the tools available during the buying process.

There is a trend in mobile digital shopping and in consumer's preference to use text messaging rather than voice calling on their mobile device. While sellers have adopted text messaging, the technology can be limiting since text messages have a 160 character limit and must be kept short on a back and forth correspondence. Whereas the flow of a voice conversation may provide a more fluid means for a seller to obtain information about the consumer's interests, texting requires a more judicious approach to the communication between buyer and seller, making it important for the seller to get as much detail as possible. The seller also desires the same portability as the consumer but is faced with having to conform to the established sales processes and technology installed by the store owner.

### SUMMARY OF THE INVENTION

The present invention provides tethering and tagging that addresses the problems above. It provides an alternative to initiating a voice call, specifically text messaging, which provides the consumer a sometimes less intimidating method of communicating with a seller. Tethering provides the seller with the portable means to text message a consumer (“end-user”) from a mobile device while keeping an ongoing record within the main system. A tagging element provides the seller with detailed information about the product for which the end-user has an interest. This is done through a direct database query and does not require the end-user to enter or select the product on a web page (or mobile web page) form. This provides the seller with more detailed and relevant information without burdening the end-user with entering such details. This creates a more efficient exchange between the end-user and seller. This system also archives and manages sales opportunities through text messaging.

The buyer, for his part, can approach a sales person in a manner which is less intimidating and more anonymous. The buyer has a great deal of product information available on the mobile device but may have questions or inquires for a sales agent, but does not wish to engage in a voice conversation. Because of the limitations of the mobile experience, the buyer will not likely fill out a form with great detail on the product of interest and must be presented with the easiest way possible to take advantage of the text medium. Being able to communicate in a meaningful yet less intimidating way with the sales agent is of great benefit to the Buyer.

### BRIEF DESCRIPTION OF THE DRAWINGS

FIGS. 1A and 1B are block diagrams showing the tethered response mechanism in accordance with the present invention;

FIG. 2 is a logical message flow diagram;

FIG. 3 is a block diagram showing detailed listing information.

FIG. 4 is a screen shot showing a message generated in accordance with the present invention;

FIG. 5 is a screen shot showing the Tethered Response Mechanism as a mobile web page;

FIG. 6 is a screen shot of the TRM showing communications with options to send communications to CRM or agent and enter details about end-user;

FIG. 7 is a screen shot showing the send to the Customer Relationship Management (CRM) system form;

FIG. 8 is a screen shot showing the end user customer details collection form; and

FIG. 9 is a depiction of the identification information stored in the database.

### DETAILED DESCRIPTION OF THE PREFERRED EMBODIMENTS

In describing the preferred embodiments of the present invention illustrated in the drawings, specific terminology is resorted to for the sake of clarity. However, the present invention is not intended to be limited to the specific terms so selected, and it is to be understood that each specific term includes all technical equivalents that operate in a similar manner to accomplish a similar purpose.

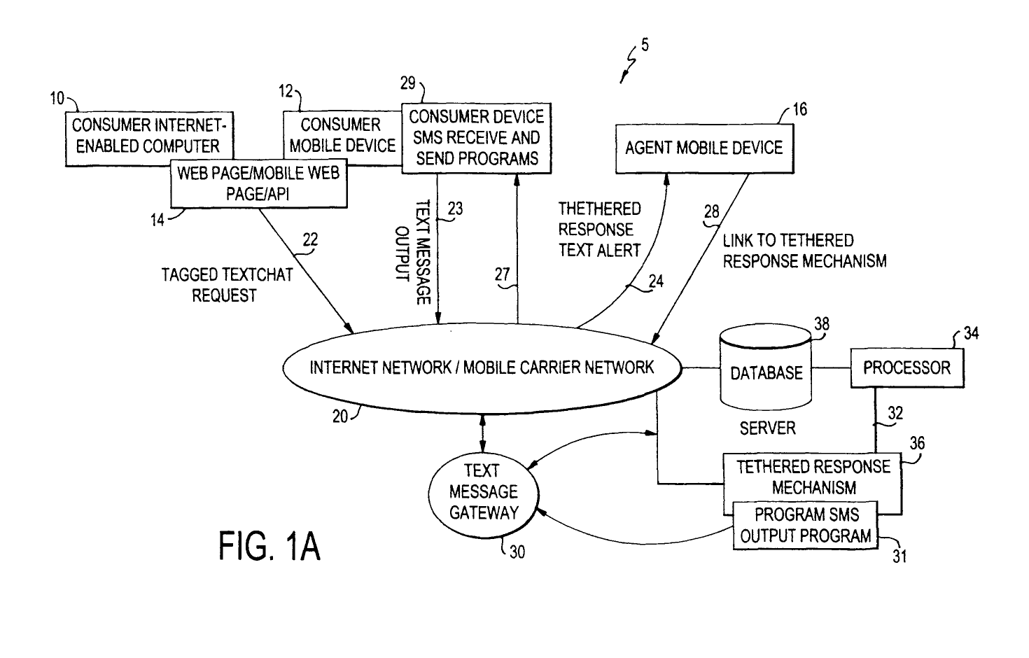

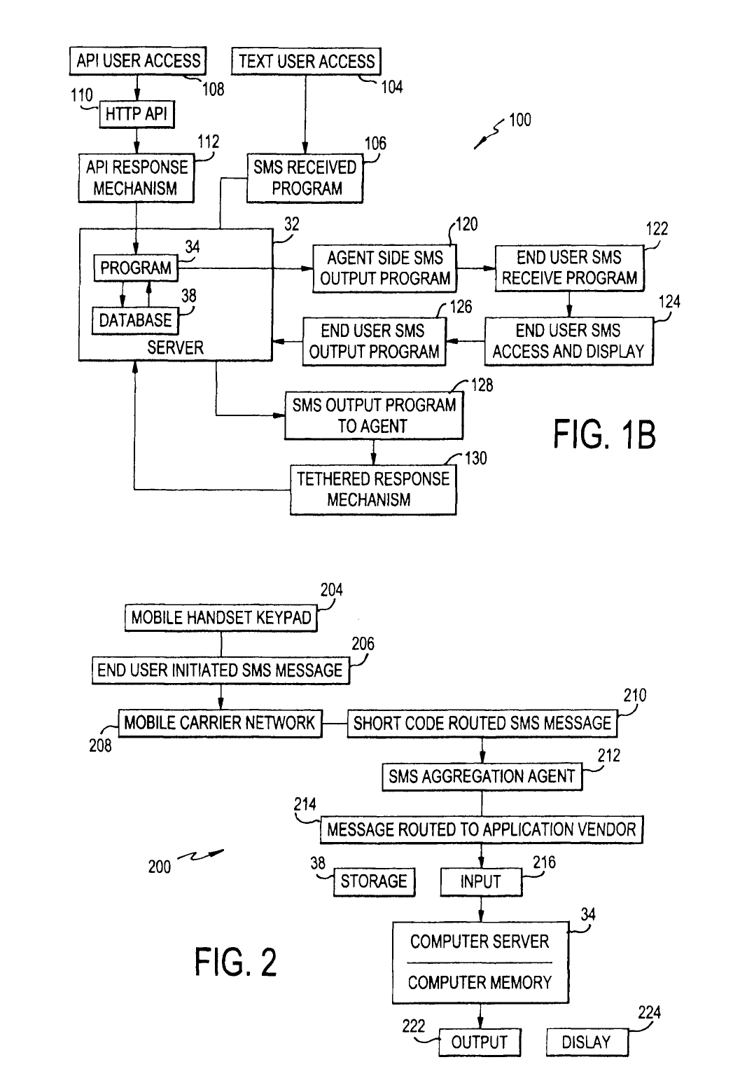

Turning to the drawings, FIG. 1A shows an overview of the system 5 and method of the present invention. As shown, the system 5 generally includes consumer components, agent (seller or user) components, and a backend system. The consumer components include a personal computer 10, mobile device 12, and web interface 14 such as a web page or the like. The web interface 14 can be stored on or accessed by the consumer computer 10 and/or mobile device 12, and provides access to the Internet 20. The seller components include a mobile device 16, but can also include a personal computer. The backend includes a text message gateway 30, server 32 which includes a database 38 for storage, a processor 34, and Tethered Response Mechanism (TRM) 36.

The system 5 provides bi-directional conversations between a World Wide Web desktop interface at the server 32, a standard mobile device SMS messaging application provided on a consumer's mobile phone 12, and an agent's mobile device 16. The server 32 is accessible by a desktop browser 14 or a mobile web browser 14 on the mobile device 12. Unlike standard desktop and smart phone instant messenger products, the system 5 does not require a customized software application to reside on the customer's mobile device 12 or desktop 10 or the agent's mobile device 16. That is, the invention operates with the standard texting capabilities of the mobile devices 12, 16 and with a standard desktop browser 10 or with the mobile web browser of the mobile devices 12, 16. Text requests are initiated on a desktop browser at the desktop computer 10, server 32, browsers at the mobile devices 12, 16, or through the text message interface of the mobile devices 12, 16. The system captures and stores, in the database 38, the bi-directional exchange of messages that are sent between the SMS application of the mobile devices 12 and 16 and the desktop or mobile device web page 14 at desktops 10, 32, via the server 32 (which is accessed through the mobile cellular network or World Wide Web network 20), and the accepted standard programmatic web page form capture of the desktop browser and processor 34.

The text messaging gateway 30 handles text communications sent through the mobile carrier network/internet network 20, such as messages from the consumer computer 10 or consumer mobile device 12 to the server 32 and optionally, through extension the agent mobile device 16 and vice versa. The server 32 includes a processor 34, database 38 and TRM 36. The server 32 processes all text messages as an intermediary between the end-user's mobile device 12 and the mobile device 16 or desktop device 32 of the agent through a programmatic interface with the text message gateway 30. The server 32 interacts with the gateway 30 which in turn interacts with the mobile carrier/internet network 20.

The TRM 36 is a function, module or component in the server 32 that extends the ability to respond to the end-user from the agent mobile device 16. This is done through a specialized mobile web page that is accessed through a static URL that is sent via a text message 24 to the agent mobile device 16. The URL text is sent via the gateway 30 and through the mobile carrier/internet network 20 to the agent mobile device 16. The TRM 36 communicates with the gateway 30 as a function of the server 32. The server 32 stores all text communications from the TRM 36 in the database 38. Thus, the processing and sending of the URL to the agent, and the act of accessing, reading, and responding to the end-user inquiry though the agent's mobile web form creates a “tethered” response mechanism which is an extension of the core text system. Thus, the TRM 36 is implemented as a mobile web page that contains the text messages transmitted between the end user device 10, 12 and the agent's mobile device 16.

The following terms are generally understood in the context of the present invention, and as used herein, to have the following illustrative and non-limiting meanings. A mobile device includes any mobile device participating on a mobile carrier's network and is capable of sending or receiving text messages. A mobile carrier is an entity that provides a cellular network to its mobile handset customers and provides interoperable voice and data access to a global cellular network. A mobile carrier aggregator is an entity that routes text message traffic to many mobile carriers via the use of a Common Short Code (CSC). A CSC is a unique sequence of numbers, usually 5 or six characters in length, used to accept and route a text message to a particular computer system function, such as generating a billing event or a logical process. A Short Messaging Service (SMS) is a carrier adopted technology behind text messaging services. The SMS message is limited to 160 characters.

A text message is a message, using short messaging service technology. The text message is generated by the handset user and is limited to 160 characters. Text messages can be generated by a handset to a computer (text message), from handset to handset (peer-to-peer), or computer to handset (SMS). A mobile web is similar to the World Wide Web for computers, but specific to mobile devices on mobile carrier networks. The mobile web uses the Wireless Access Protocol (WAP) as the underlying technology behind the connection and transfer of data. An end-user refers to the participant in the service that uses the invention to communicate with an agent using SMS through a desktop 10 or a mobile device 12. The agent refers to the participant in the service that uses the system via the mobile device 16 to communicate with an end user at the computer 10 or mobile device 12 using the interface 14 or the TRM 36. Agents represent the commercial customers of the system 5.

This invention relates to an automated method for engaging in a conversation with a customer via SMS. The technology uses a series of events to exchange SMS messages while archiving them in a web-based application where they can be stored and managed. Notably, this technology does not rely on a downloadable application, which is the traditional means technology behind “Instant Messenger” chat. Instead, the end user uses the standard text messaging interface/function on his mobile device and the agent uses the World Wide Web interface of the present invention. The present invention also allows richer details about the product in which the end user is interested, and the ability for the agent to manage a message conversation through a mobile, tethered means. A downloadable application is not needed for the SMS chat invention.

The processor 34 communicates and stores information in the database 38 using various identification information. As shown in FIG. 9, the identification information can include an agent ID, agent affiliate ID, session ID, record ID, product ID, Client ID text message ID, and vehicle ID. As illustrated, the three primary identifications can be the affiliate ID, client ID, and record ID. The affiliate ID can include one or more agent IDs, session IDs, and/or text message IDs. And, the record ID can have one or more vehicle IDs and product IDs.

The agent affiliate ID is assigned by the processor 34 and stored in the database 38 when the affiliate is set up in the server 32. The number is randomly assigned to represent the affiliate in the database 38 and throughout operation of the processor 34. The affiliate agent ID is a “parent” to the agent ID, such that there can be more than one agent ID associated with a single affiliate ID. All of the agent IDs must have a parent affiliate ID, such as the agent's employer. The agent ID is assigned by the processor 34 and stored in the database 38 when an agent is set up in the system. The number is randomly assigned to represent an agent in the database 38 and throughout operation of the processor 34. An example of an affiliate ID can be “McCluskey Chevrolet” and an agent ID can be “Jim” (a sales agent for McCluskey Chevrolet). As shown, the affiliate ID can include data elements such as the affiliate name, affiliate address, affiliate country, and affiliate contact information. And the agent ID can include for instance, the agent name, agent contract information, agent mobile device phone number, and alert trigger setting.

The session ID is assigned by the processor 34 and stored in the database 38 when a chat session exchange begins. The number is randomly assigned to represent the session in the database 38 and throughout operation of the processor 34. All text events are assigned a session ID and relate to an affiliate ID and agent ID.

The text message ID is a randomly assigned number assigned by the text processor 34 to identify a given text message event. Each inbound and outbound message is assigned a text message ID. Each session ID may be associated with one or more text message IDs. The text message ID can be used, for instance, when searching for information

The client ID is assigned by the processor 34 and stored in the database 38 when an end-user is created in the server 32. The client ID may be created, for instance, when the user sends the initial chat request 22, 23. The client ID is linked with the end-user's mobile device number and other information such as name and address, which can be entered by an agent through data input on processor 34. An example of a client ID can be “John Doe.” As shown, the client ID can include data elements such as first name, last name, mobile device phone number, and opt-in status.

The record ID is assigned by the processor 34 and stored in the database 38 when a client ID is created and is related to the client ID. The record ID has associated data that is passed through the API through tagging, or is entered in the client edit screen on the server 32. Among the information stored with the record ID and associated with the client ID can be product details, such as make, model, year, price, stock number, exterior color and details about the end-user such as email address. The number is randomly assigned to represent the record in the database 38 and throughout operation of the processor 34.

The product ID and vehicle ID are used to relate the product to the database 38. The product ID is entered in the database manually or by automated means and is assigned to the record ID. The product ID is generally understood by the processor 34 and other systems and is the common relational “link” used to identify the product in the tagging invention. Common product ID examples are stock numbers or vehicle identification numbers (VINS). The product ID can be any ID agreed upon and recognized by two systems.

The vehicle ID is a type of product ID and is universally used to identify a distinct vehicle.

All IDs are used by the processor 34 to retrieve information from and store information to the database 38. Other information is also stored and associated with one or more of the IDs above. They are assigned values in variables used by the processor 34 to associate as much information to the record ID as possible, which is in turn used by the tagging component of the invention.

One illustrative, non-limiting implementation of the system 5 is shown in FIGS. 1-3. Here, an affiliate operates a web page that offers various products (for instance, vehicles) at one or more product web pages. During a setup process, the affiliate registers with the server 32 by providing certain information such as the affiliate name and contact information, the names and contact information for its sales agents, and possibly the URLs for each of the affiliate's product web pages. The server 32 generates a unique affiliate ID for the affiliate, and unique agent IDs for each of the agents. One or more of the affiliate's product web pages (which can be a mobile web page) can offer the option for the consumer to chat via text messaging with a sales agent. The affiliate then provides a unique link or unique keyword command at each of the product web pages. The link and keyword are unique to that affiliate and may be associated with a vehicle ID or product ID. The affiliate ID, agent ID and associated links and keyword commands, as well as the vehicle ID and/or product ID, are stored by the processor 34 in the database 38.

Referring to both FIGS. 1A, B, a message tethering operation 100 is shown. The tethering operation 100 is initiated when an end user sends a request 22 for a text response from the consumer's mobile device 12 or desktop 10, such as through the affiliate's product web page or the user's mobile page 14. Thus, if the user clicks on the link at the affiliate's product web page, a user request 22 (FIG. 1A) is generated and sent to the server 32 via the network 20. The request includes or identifies the affiliate ID.

The consumer request 22 includes the submission of data or “variables” that are collected by (a) filling out a web page form on a mobile carrier website where variables are collected and sent through an open HTTP protocol application programming interface (“API”) 108, (b) filling out a web page form on a standard website where variables are collected and sent through the API 108, (c) variables collected through any means and passed through the application user interface regardless how the variables are collected by a partner party (through an API 108 on the system). In the API scenario, conversations can be initiated through a variety of non-specific sources that can pass data, through the API, to the present system. The typical sources that make use of the API are: a) mobile website, hosted on any server connected to the Internet/Mobile Carrier network 20; b) World Wide Web site, hosted on any server connected to the Internet/Mobile Carrier network 20; and c) other independently-owned software products hosted on any server connected to the Internet/Mobile Carrier network 20.

The system processor 34 operates a software program that is invoked through the API user access 108. Here other software, both third party and software internal to the present invention, can use the API 14 (FIG. 1A) to send variable information and invoke all the functions of the system 5. The API is a way for other systems to communicate with the server 32 so that the full function of the system can be used interoperably with mobile websites, desktop websites, or other systems that benefit from the server functions. The HTTP API 110 is the access protocol required for use with the API. The API response mechanism 112 allows the API to communicate back to the initiating system, mainly to verify the success or failure of the API communication and to allow passage of the API request to the server 32.

As further shown in FIG. 1B, the tethering operation 100 can also be initiated by the user texting the keyword command provided at the affiliate's product web pages. This can be done by: 1) a text message “keyword” command, with a defined keyword sent to a mobile short code in the user access 104 process; or 2) the World Wide Web graphical interface, in the form of an invitation from the agent where the end-user submits variables in a form that is sent through the API user access 108. At the text user access 104, the end user can send the request 23 (FIG. 1A) for a text chat through the use of a keyword that is sent to a short code. At step 106, the SMS received program recognizes a command keyword, initiated in the text user access 104. The command keyword is set up in the server 32 as part of the affiliate account setup. Accordingly, each keyword is unique to a specific affiliate ID and either a record ID or vehicle ID. All text correspondence is stored with the agent ID and the parent affiliate ID through a relation that is established when the affiliate is setup with the processor 32 and stored in the database 38. Thus, when the keyword is received by the server 32, the processor 34 takes the command keyword and finds the related affiliate ID in the database 38.

The API access 108 and the text access 104 both invoke the same trigger function. And during both of these processes 104, 108, the processor 34 receives key required variables from the end user, such as mobile phone number, vehicle ID and end-user generated text, sent as a string of characters through a variable and stored with the session ID and non-required variables such as first name, last name and comment that are sent through the API 108 and stored in the database 38.

At this point, the TRM operation 100 has been invoked by the end user sending a request 22 via 108 or a request 23 via 104, and the flow is now at the server 32. The API requests 22 identify the affiliate ID with value, the name variable with value, comment variable with value, and product ID variable with value, URL variable with value. And the text keyword command requests 23 also identify the affiliate ID. The server 32 uses the mobile phone number (provided by the user with the API request 22 or identified in the text message request 23) to determine if a client ID exists for this particular user by searching for the user's mobile phone number in the database 38. If a client ID does not exist, a unique client ID is created by the processor 34 and associated with the user's mobile phone number and any other information that has been obtained through the request process. If a client ID exists, that information is associated with the present request.

When the request 22, 23 is received, a session ID is also created, assigned to the request by the processor 34 and stored in the database 38 associated with the affiliate ID value and client ID. A text message ID can also be generated by the processor 34 for the request. The request 22, 23 can also include or be associated with (in database 38) a record ID (vehicle ID and/or product ID).

If the combination of the text message ID and the tethered alert is “on” (i.e., the setting has the value of (1) in the database 38, the triggered function generates a text message referred to herein as a tethered response text alert 24. The tethered alert 24 is set to on or off in the setup console of the processor 34 as an optional setting for the agent. The tethered alert message includes a link to the mobile phone number(s) of the agent(s) specified by the agent(s) in the server 32 during setup and stored in the database 38. All tethered alert messages 24 are sent to the agent's number that is stored in the database 38 and associated with the affiliate ID.

The tethered alert message 24 contains a link to the mobile web page component of the TRM as well as the session ID that was created as a result of request 22. A programmed function within the mobile web page component of the TRM accepts the session ID variable value and retrieves the tagged information variable values, stored in the database 38 and associated with the session ID, from the database 38 using an SQL command using the session ID. The retrieved information is displayed on the mobile web page component of the TRM, as shown in 410. The triggered alert message is sent to all agent IDs related to the affiliate ID in the database 38 and set on the server 32 during the affiliate set up process. Any agent that receives the triggered alert can follow the link to the mobile web component of the TRM and generate a response to the end-user through the TRM process. The text exchange is stored with the session ID and associated to a default agent ID which is associated to a parent affiliate ID.

Simultaneously, the interaction details, which are stored as inbound and outbound messages and associated with a session ID are stored to the database 38, which are accessible in the affiliate account through structured query language commands executed by the processor 34. The server 32 transmits the tethered alert message alert 24 from the TRM 36 through the gateway 30 and network 20 to the agent's mobile device 16. The agent then can access the mobile web component of the TRM by clicking on the link 28.

The TRM 36 provides the agent with the ability to respond to the text message chat request 22 on a mobile device 16 through an accessible URL link 28, sent with the tethered response text alert 24. The agent accesses the URL by clicking on the link 28, which initiates a programmed form on the mobile web browser of the mobile device 16. The agent accesses the user's message and inputs a response of 160 characters or less and clicks on the SEND command 430 (FIG. 5) displayed on the mobile web page. The information is stored in the database 38, and the response 420 (FIG. 5) is sent by the server output program 31 through the text message gateway 30, the mobile carrier networks 20, to the end user's mobile device 12 as a text message 27. When the user sends a text message in response to the agent's text, the user's mobile cell phone number is matched in the database 38 and the text message is then linked to the session ID stored in the database 38 and presented on the mobile web page. A text message is then sent to the agent with a link to the updated mobile web page. The cycle is repeated until the session has ends.

Thus, a user can invoke the tethering operation 100 through either the API user access site 108, or via text access 104. The server 32 facilitates 2-way interactive conversation using text messaging and the digital management of conversations. The server 32 includes a processing device 34 that operates software, and a database 38. The inbound text messages 22, 23 from the user to the agent, as well as the messages posted by the agent on the TRM mobile web page 36 and sent as text messages 27 to the user, are stored as text in a session record in the database 38, keeping a record of the text conversation (back and forth) between the agent and the end-user. The alerts 24 can also be stored in the database 38.

Steps 120-130 (FIG. 1B) represent the mechanics of the outbound text service as it relates to the system 5 and the basics of the service. The processor 34 takes the user input received from the user's initiation request 22, either a command keyword (steps 104-106) or variables collected and sent through the API (steps 108-112). When a mobile device phone number is received through request 22 or 23, a client ID is created by the processor 34 and stored in the database 38 and associated with the mobile device phone number of the end-user. Output text is created by the agent and is submitted to the processor 34 SMS output program 120. The output program 120 retrieves the end-user's mobile device phone number through an SQL command using the client ID to retrieve the information and sends a text message 27 through SMS to the end-user's message receive program 29, step 122. The end-user reads the message through the mobile device 12 access and display program, step 124, and submits a response message 31 to the SMS output program of the mobile device, step 126. The response message 31 is added to the mobile web page of the TRM 36, and an alert message 24 is sent to the agent mobile device 16 with a link to the updated mobile web page.

Once the initial API request is made, the text messages go directly through the network 20 to the server 32. The end-user's message is accepted by the server 32, stored with the session ID in the database 38, and displayed by the processor 32 in human readable form. The agent creates input in an input program within the processor 34 which is submitted to the agent-side output program 120, and the cycle is repeated until the SMS exchange between the agent and the end-user is exhausted and the session is closed by the agent through a close session function on server 32. Each time a message comes in to the system or goes out from the system, the message is assigned a text message ID and related to the session ID. The text message ID is stored in the database 38 and related to a session ID and can be used, for instance, for tracking and reporting.

The server 32 processes the input from the user's initiation request. steps 104 or 108. depending on the initiation method invoked by the end-user. The trigger function submits: (a) a programmatically devised link that leads to an input-collecting mobile web page where the agent can create SMS output; (b) static and pre-configured text such as a friendly greeting “hello-here is your link. Please respond promptly”; (c) end-user details, appended to the (b) such as the end-user's name and reference to the product of interest (if available and sent through variables in the API 110). (a), (b) and (c) are formatted into a human-readable “Tethered Response Alert” text message and submitted to the SMS output program. Thus, there is the trigger function and the tethered alert text message. The text is sent through the updated mobile webpage with a series of triggered alerts. Each time the user sends back a response, the alert carries a link with the updated page.

The triggered alert text message is then sent via SMS to the agent's mobile device 16, whose mobile device number is stored in the database 38 and associated with and agent ID, identified and set in the configuration settings section of server 32 and stored in the database 38. Upon receipt of the message, the agent accesses the devised URL, invoking the TRM 130. The cycle of SMS communication between the agent and the end-user repeats until the exchange is exhausted. Each response from the end-user invokes steps 128 which the trigger function sends an alert text message to the agent if optionally set, including the URL to the TRM. Each response also invokes 130 which is the actual text message exchange between the agent and the end-user—the “conversation”.

For example, suppose a consumer John Doe goes to ABC Ford Dealerships mobile website. John Doe opens a web page for a new Ford Explorer and reviews the details. Interested, he clicks on “Text Message with ABC Ford now!”. John enters his name, mobile phone number, and a comment—“What color is this car?” John uses the “submit” button on the page. The entered variables are submitted to a programmed script in the processor 34 which stores the variable values for a phone number that is associated to the client ID and the session ID, name which is associated to the client ID, and the text string comment which is associated with a text message ID and session ID in the database 38 as a record associated with a session ID. That information is stored along with vehicle variables retrieved from a database, web page, or any programmatic means by a third party. Details such as vehicle make, model, exterior color, interior color, price, and stock number are sent and stored with a text message ID in the conversation record associated with the session ID in the database 38. The values of the detail variables are stored in database 38 with a record ID.

Simultaneously, the processor 34 invokes the triggered function and passes the collected variables and record details that are retrieved from the database 38 to the agent side SMS output program for the agent ID on record if ABC Ford and ABC Ford's agent “Jim” tethered alert is set. The trigger function retrieves Jim's mobile phone number from the database 38, formulates a link to the Tethered Response Mechanism which is comprised of, among other things, a mobile web page entry form of the TRM 130 which is hosted by the server 32 and displays, for example, the end-user's name, text comments and tagged variable values such as exterior color, make, model, price, stock number, and URL to a mobile web listing of the product, if available, such as shown by the example depicted in 406 (FIG. 5). The link is sent as an alert signal 24 to Jim's mobile phone number along with a pre-configured text greeting. Jim receives the text message 24, clicks on the link 28, and is presented with a mobile web page that serves as the TRM 36. Jim types a response to the question, and selects submit. The return message is sent from the processor's SMS output program to John's mobile device text message receive program 29 through the mobile network 20. John gets the message in his phone's text message program. After the initial request (or from the initial request if it is a keyword command) the message interaction goes from the program on the server 32 directly to the text message inbox of the end-user's mobile device 12. The agent's actions are tracked and archived for the affiliate but the end-user can just use their standard and familiar text message component of their phone.

Referring now to FIG. 2, the general SMS interaction with a user-generated message text message is shown. FIG. 2 provides additional detail of the text user access 104 and SMS received program 106 of FIG. 1B. A string of characters is sent to a short code through the user's mobile carrier network 20. The network routes the message through an aggregation agent and is, in turn, routed to the application. The message is stored in the database 38 and computer memory. The message is processed by the computer 34 and the application. An agent is alerted to the incoming message and can respond accordingly using the functions of the application and the specific components in this document. For instance, an end-user is on a web site that sells automobiles, he sees a car that is of interest and an invitation to “chat” with an agent about a vehicle by texting the command keyword “chat” to a short code 45555. The end-user accesses his phone's text message program, inputs 45555 as the number to which he whishes to send. He inputs the word “chat” and submits. The steps 104-130 are invoked as depicted on FIG. 1B. The keyword is associated with the affiliate ID. The processor 34 receives the keyword and looks up the associated affiliate ID in the database 38, creates a session ID, the trigger function is invoked, and any associated agent IDs with the affiliate that should receive the tethered alert text message.

A mobile handset keypad (input device) 204 of a mobile device 12, 16 sends a text message 206 to the mobile carrier network 208 for routing to the server 32. The messages are routed through the network by Short Code and passed to the proper aggregation agent, step 210. The SMS aggregation agent 212 receives the routed SMS message and in turn routes the message to the proper applications vendor 214, in this case, the server 32. As further illustrated in FIG. 2, the server 32 can have a processor 34 with memory, storage or database 38, an input 216, an output, 222, and a display 224. The input can be a wired or wireless connection that receives information from another computing device, or can be a manual input such as a keyboard, mouse or touch screen. The output 222 can be a wired or wireless connection or the like to transmit information to another computing device. In addition, the processor 34 can generate reports based on the information stored in the database 38 and output those reports to the display 224 and/or output 222.

The server 32 receives the text message input, the computer server processes the message, output is generated, results are stored, and the processed output is displayed on the system and within the TRM 36 mobile web page.

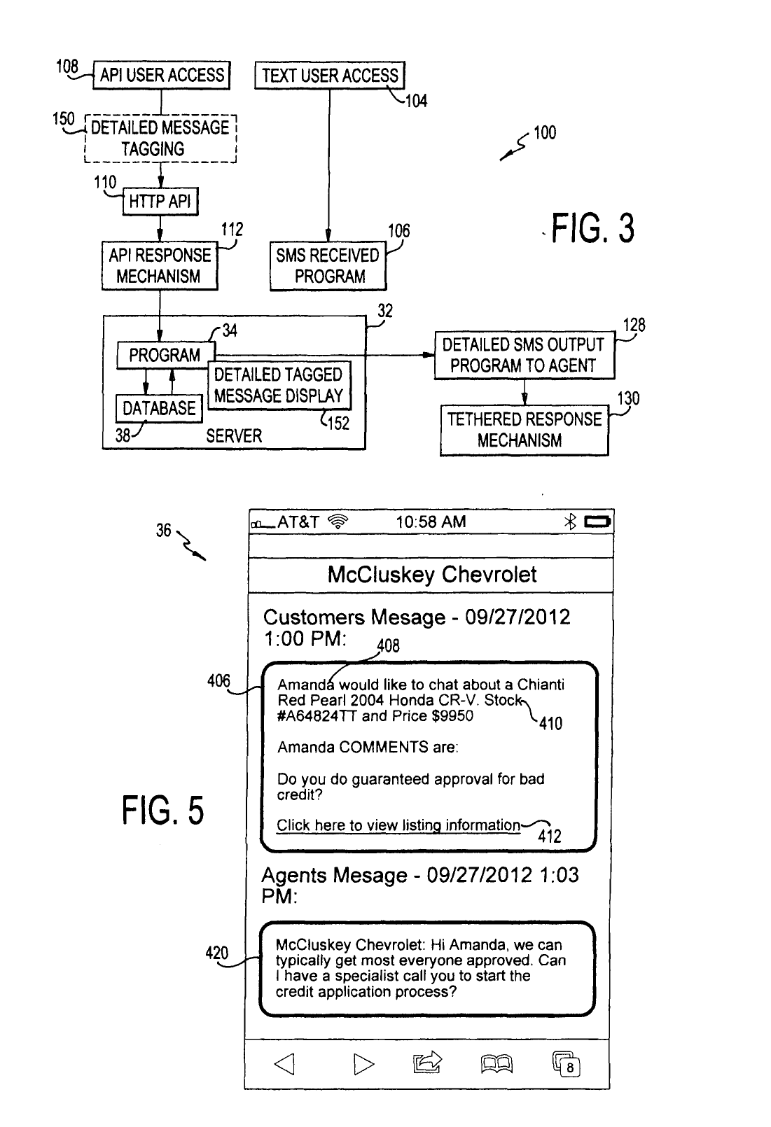

Turning to FIG. 3, the user initiates a text conversation by performing an action that sends request information over the HTTP API. This is typically the act of filling out a mobile web form. If the form is initiated while viewing specific details of a listing, such as a car or real estate property, the listing identification string is queried in an external database and passed to the API as variables. The variables are formatted into a logical string and displayed in the interface, the Tethered Response Mechanism, and all other agent alerts within the system.

FIG. 3 is substantially the same as FIG. 1, except adds message tagging at steps 150, 152. One feature of the present invention includes listing details, tagged from the listing being viewed by the customer are captured via the HTTP API and displayed within the interface. This feature gives the agent specific details regarding the item of interest, thereby enriching the value of the service that can be provided to the end user. The user can tag product listing details from a listings detail page and append the listing information to the initial inquiry. As end-users search or browse product details, they are invited to initiate a messaging session. If the messaging session is initiated at the detailed listing level, specific product information is tagged through a database query and appended to the initial chat inquiry, thus giving the agent detailed information on the product of interest. The variable values are stored in database 38 and associated with a record ID and related to a client ID.

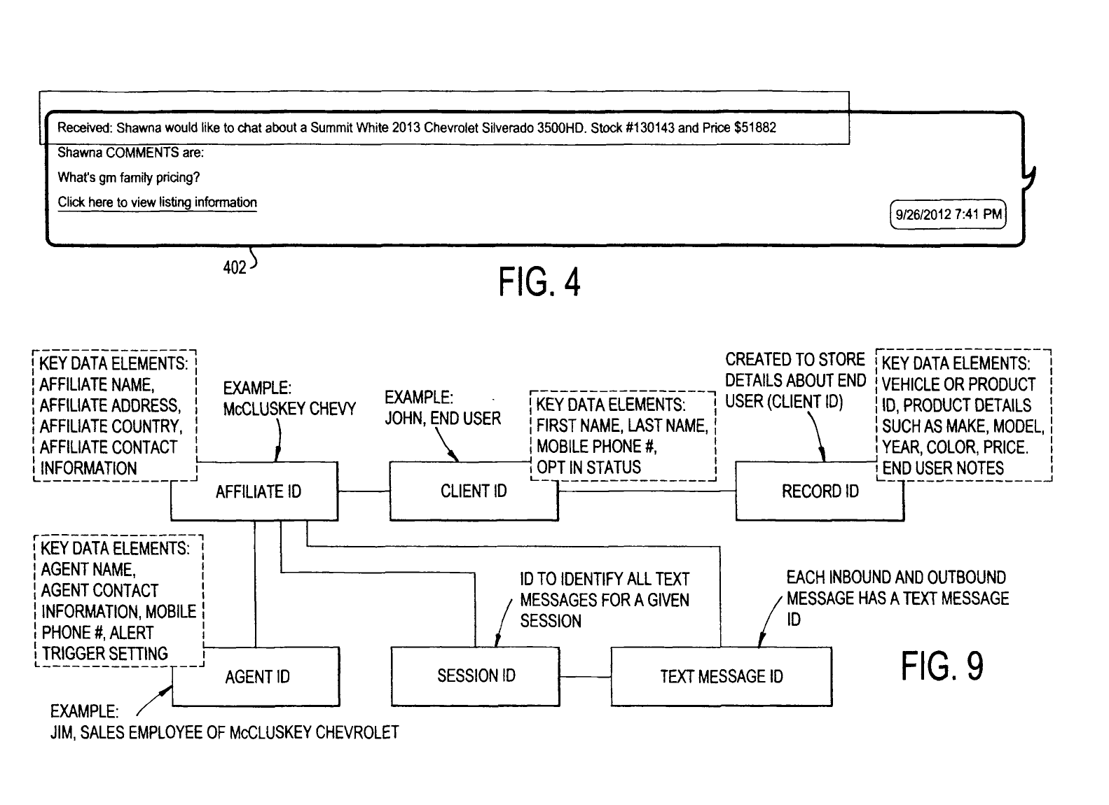

To provide more details about a specific product, without end-user interaction. message tagging provides the ability to submit retrieved detail variables about a product (a vehicle for example), such as make, model, interior color, exterior color, mileage, price, stock number through the HTTP API 110. For instance, end-users on third party product systems and systems can initiate the service while viewing a specific detail product page. A special link is displayed on the details page if the agent ID is set in the server 32. While viewing the specific details, the variables are stored in computer memory through programmed variable assignments 14 (FIG. 14). When the end-user submits the text message initiation form with basic details, the basic details and the variables are “tagged”, step 150, sent via the HTTP API 110 and submitted to the server 32. In addition to invoking the SMS processes identified herein, the agent can also see the tagged details in an output display box on the server 32 (as visually depicted in FIG. 4), step 152.

One illustrative non-limiting example of the invention is shown in FIGS. 4-8, where FIG. 4 is a visual depiction of a messaging session with tagged detailed information (agent's view) 152 (FIG. 3) which is the result from step 150 (FIG. 3). This visual depiction represents the output 402 displayed for an end-user generated text message request 22 (FIG. 1A) where the end user requested information while looking at a detailed product description (in this case, an automobile). The output 402 is a screen shot depiction of the agent view of an initiated text message (which appears as a graphical callout). In addition to a date/timestamp which is automatically tagged to the text message request, the end-user's name (if provided as a variable) and comments (if provided as a variable) are displayed to the agent. The boxed items at the first line within the callout represent information that has been tagged, and provided in the display box. The tagged data includes information provided by the end-user and if available, a record identification number (a number used in a system external to the system, sent as a variable value) that can be used to query a database for details about the product. A record ID is a variable value like the other variable elements. The query is performed by structured query language and the results are tagged to the end-user information to create a complete record with pertinent information for the agent.

The embodiment of FIG. 4 illustrates the agent's messaging window that is revealed as a popup on the desktop version of the invention. Within the popup window, the highlighted message shows the detailed listing information that has been tagged 150 from the source database and sent over the HTTP API 110. The agent can see a range of details about the specific listing they were viewing at the time of initiating a text conversation. In this case, the user is interested in a specific vehicle on a mobile web site.

FIG. 5 is a visual depiction of the agent view of the TRM 36 mobile web page from the agent's mobile device 16 (FIG. 1A). In FIG. 4 the end user is interested in a specific vehicle which has been tagged and sent over the HTTP API. The agent has been configured for the TRM 36 and therefore receives a text message alert with the end user's specifics. The agent's response and all elements of the “conversation” are shown. The agent is viewing and participating on his mobile device through the TRM 36. In this example, the invention provides a complete mobile services package to auto dealers. Among the services are mobile web sites, iPhone and Android Smartphone applications, short code text message marketing, and Dealer messaging. While the present invention can be applied to any vertical market or industry, illustrative services include the automotive retail, rental real estate and New Home real estate vertical markets. A hosted version of the product can be provided, where customers serve as their own agents, and a “managed services” version of the product where a central host acts as an agent on the customer's behalf. The end-user does not access the mobile web page. Once the end-user fills out the initial form for request, the text messaging moves to the text component of his/her phone.

The Tethered Response Mechanism 36 is a mobile web page that is devised and rendered upon being invoked by the triggered process. Once the agent has received a tethered alert text, a URL is created and formatted within the text alert. When the agent follows the link, the Tethered Response Mechanism screen of FIG. 5 is rendered. The screen can include a header 404, window 406, and response window 420. The header 404 is formatted and displays the affiliate (seller) name so the agent is aware of the agent affiliate to be represented. The agent information is extracted from the database 38 (FIG. 1B) by matching the record ID (from the user's request) with the agent affiliate ID, which is assigned automatically in the database 38 upon set up of the agent affiliate account in the processor 34 (FIG. 1B). The initial window 406 is the end-user's initial chat request, and can include end-user information 408 that the user input into the system, any tagged information 410 retrieved with the tagging operation, and a link 412.

In the example of FIG. 5, Amanda was viewing, on McCluskey Chevrolet's mobile website, a particular vehicle. Because McCluskey Chevrolet is a customer and has been set up in the system with an agent affiliate ID in the processor 34 (FIG. 1B), a special link is displayed on the listing that invites Amanda to “Text Message with McCluskey”. Amanda clicks the link and is presented with a data collection form, as indicated in steps 12, 14 (FIG. 1A). Amanda enters her name, mobile phone number and comment in the form. Amanda's name, phone number and comment are assigned to a variable and sent, with the vehicle identification number and the agent affiliate identification number as variable values to the mobile web page API 14 (FIG. 1A). The variable values are accepted by a script. The server 32 (FIG. 1A) (a) stores the introduced variable values to the database 38; (b) formats the variable values (FIG. 5, step 406); (c) performs a database lookup, in the database 38, of the vehicle through the vehicle ID and stores the make, model, exterior color, year, trim, stock number and price from in temporary memory (such as an array in the programming which is temporary and can be used by the system as part of the processing); (d) constructs a URL to the page that will display (b), (c); and (e) invokes the trigger function to send the tethered response alert text message 24 to the agent mobile device 16 SMS output program 128 (FIG. 1B). The agent receives the alert text message, follows the link and is presented with the Tethered Response Mechanism mobile web page 406 (FIG. 5). The agent can type a response to the inquiry found in 406 and start the looping process of 120, 122, 124, 126 with additional alert process of 128 and 130. Block 402 (FIG. 4) represents the tagged information.

The display on the Tethered Response Mechanism 36 mobile web page shows the agent the variables collected from the end-user via the mobile web form-name and comment, the static pre-programmed friendly text “would like to chat about a” and “COMMENTS are:”, and the variable values retrieved in the database during (c). The agent is also presented with a link 412 to the specific product of interest to the end-user (if available), the very same web site page that was being viewed by the end-user Amanda. The agent receives the alert text message 24, follows the link and is presented with the Tethered Response Mechanism mobile web page, step 406 (FIG. 5). The agent can type a response to the inquiry found in 406 and start the looping process of 120, 122, 124, 126 with additional alert process of 128 and 130.

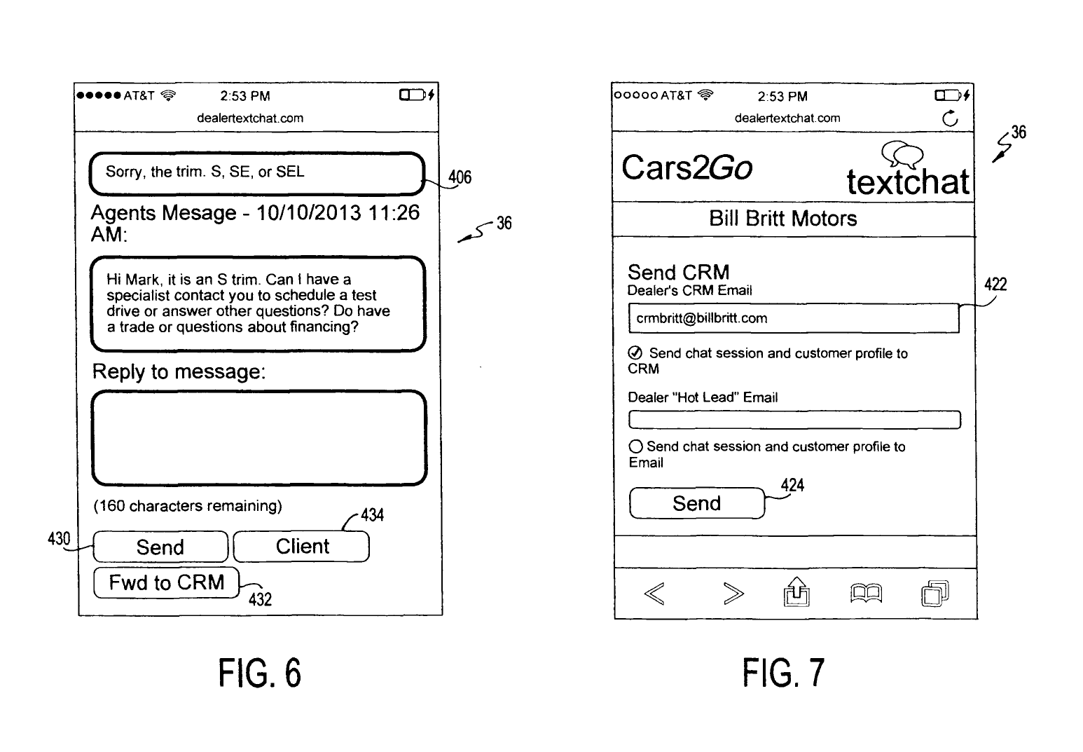

FIG. 6 is another screen shot view of the Tethered Response Mechanism as a mobile web page. Here the user has accessed the webpage dealertextchat.com through a mobile device, as shown at the top of the screen 16 (FIG. 1A). The user has sent an initial text message request 22, 23, and the agent has responded by clicking on the link 28 to the mobile web page, steps 128, 130. FIG. 6 is the agent's view of the Tethered Response Mechanism 36 of the mobile page. The agent has several commands 430, 432, 434 available. The send command 430 is used to send a response 27 to the end-user's mobile device 12 through SMS 31. The Fwd to CRM command 432 formats the information about the product, the end-user, and the interaction between the agent and end-user in XML format. The XML is formatted in a standard email and is sent, upon invocation, to an email address(es) that is associated with an affiliate agent ID in the database 38 (FIG. 1 B). The XML formatted email provides a computer-readable record for the affiliate's Customer Relationship Management (CRM) system. The XML used is the adopted interchangeable format for a given industry, if available.

FIG. 7 shows greater detail of the Send CRM form 422, which is accessed by the agent by clicking the “Fwd to CRM” command button 432 on the Tethered Response Mobile web page form (FIG. 6). On this page, the agent can send to the agent customer's CRM system's designated email address(es). If the email address is on record in the database 38, the address is displayed during page access, as well as a standard email address(es) chosen by the agent at time of submission. The standard email address is entered into the database 38 upon setup in the processor 34. The email address(es) are associated with the affiliate agent ID in the database. The agent can either choose to send the chat session and customer profile to CRM, or to email (referred to as “hot lead” for marketing purposes). If the agent chooses to send to CRM, and email is sent in a machine readable XML which is then parsed and inserted into the affiliate's CRM. Submission is completed by use of the send command 424.

Returning to FIG. 6, the client command 434 is a function of the Tethered Response Mechanism “Client” which is the shorthand button label (short for end-user) for the agent to invoke a command to invoke the client form, enter details about the end-user. This command 434 invokes a form that allows the capture of basic end-user information. When saved, the customer information is submitted and saved to the database 38 as part of the end-user record in the server 32. Additionally, the newly saved end-user information, upon invocation. provides the option to send the information to an email address that is associated with the affiliate. The email provides, in common email formatting, a notification to the affiliate of the end-user's information and “conversation” records in the server 32.

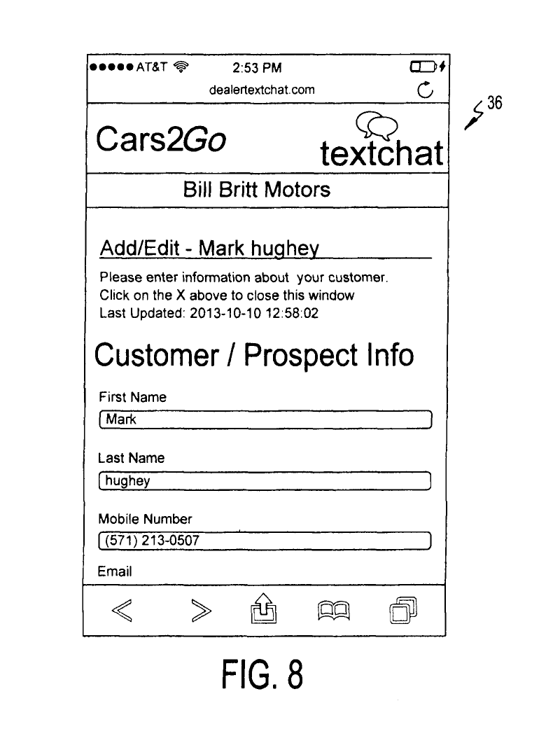

FIG. 8 is an example of the client entry form that is accessed when the agent selects the client command 434 from FIG. 6. The form is populated with any current user information that is stored in the database 38. The agent can then enter any additional details about the end-user that may have been discovered during the course of the exchange, such as last name, mobile number, and email address. Data entered in this form is stored in the database 38 and available as a record in the server 32. The recorded information is available through the standard retrieval functions of the server 32 which is typically accessed from a desktop computer through a standard web browser to manage text chatting with the end-user or look at historical text chat records.

Accordingly, the tethered response mechanism allows the agent to respond and engage in conversations from his mobile device, thereby providing the agent with optional mobility and quicker service to the end-user. The tethering aspect of this technology allows users to perform functions on their mobile device and store the results in a database 38. This is accomplished through the use of an SMS alert to the agent with a link to an abbreviated mobile web form that is used as a response mechanism. The tethering functionality allows the agent to be alerted to a messaging inquiry, respond via mobile device, enter certain details about the end-user, send the details of the text message session in both XML and standard text or html via email and have the resulting chat “conversation” be captured and archived into the database 38.

Other features of the invention include:

1. If the end-user is on a listing search service that allows viewing specific product listings, he can initiate a message session through the use of an HTTP API. The API accepts detailed information about the product at of interest.

2. In the case of mobile web sites under control of server 32, end users who initiate a chat from a specific listing will always have the listing specifics such as, but not limited to, product ID, stock number, product color, price, description and in the case of vehicles, year, make, model, and mileage.

3. Chats initiated from an area on a web page or a service that do not have listing information will have the basic required information—the cellular phone number, name and comment/question field.

4. The tethered response function is a dynamically updated mobile web page. The mobile web page displays the end user's cellular phone number, name, comments/question, and the date and time that the chat was initiated. The page also contains a text capture field used to accept and send the agent response via SMS.

5. The mobile web page contains a form with information capture fields used as a response function to a customer message session request.

6. A “Conversation” is started between the customer and the agent. Each time the customer responds from the text messaging function of his mobile device, an alert is sent to the phone of the agent with a link to a refreshed mobile page. The cycle will repeat until the conversation is finished. The point here is that each conversation “response” by the end-user provides a new TRM action, but the conversation itself is visible in FIG. 5. It updates as part of the process. In my mind, this is the “loop” of conversation that is in the diagrams.

7. The agent always has the option to log in to the World Wide Web hosted application and converse with customers through that medium. Whether the agent uses the World Wide Web interface or the tethered response mechanism, the conversation will be logged in the system and all existing functions of the system are available for use with the conversation (regardless of how the agent conducts the conversation).

Accordingly, the invention provides a tethered response mechanism 36 in the form of a mobile web page that is updated to include text messages related between a sales agent phone 16 and an end user device 10, 12. The mobile web page is designed to be accessed only by the agent, and the end-user need only use standard text messaging from the user's mobile device 12. Of course, it is also possible to enable the end-user to access the mobile web page or a different mobile web page to view information. The mobile web page can also record conversation points about the customers likes, dislikes, and satisfaction, stored with the client ID that are optionally entered by the agent on the server 32. Thus an end-user profile can be created by the agent and seen only by the agent and the parent affiliate. In one embodiment of the invention, the agent is not provided access to the user's mobile phone number, so that the agent can only contact the user through the mobile web page (which is operated by the server 32) and cannot directly text message the user's mobile device 12. In another embodiment, the agent can directly text the end-user and those messages are captured by the server. In addition, while the preferred embodiment is to send all communications via text message to the user and agent, other forms of communication can such as email be utilized.

The invention, including the server 32 and gateway 30 (as well as the mobile devices 12, 16) and/or the user computer (10), include a processor or controller to perform various functions and operations in accordance with the invention. The processor may also be provided with one or more of a wide variety of components or subsystems including, for example, a co-processor, register, data processing devices and subsystems, wired or wireless communication links, input devices, monitors, memory or storage devices such as the database 38. All or parts of the system and processes can be stored on or read from computer-readable media. The system can include computer-readable medium, such as a hard disk, having stored thereon machine executable instructions for performing the processes described (such as program 32).

While the invention has been described for use by a seller (sales agent) and buyer, other applications are possible within the spirit and scope of the invention. The unique link and/or keyword can be provided with any web page to stimulate a text messaging exchange. For instance, the link and/or keyword can be provided for a newspaper article to communicate with the article author. The invention can be utilized for any retailer or ecommerce application.

The description and drawings of the present invention provided in the paper should be considered as illustrative only of the principles of the invention. The invention may be configured in a variety of ways and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A text message tethering system for use with a website displaying information about a product, the system comprising:
a database configured to store information about the product and a first user associated with the product; and
a server configured to receive a request from a second user for text messaging information regarding the product, the second user request including second user information, wherein in response to the second user request said server determines the first user associated with the product from the database and forwards a text message alert to a first user mobile device.

2. The system of claim 1, said server further configured to provide a messaging web page including the second user information and information regarding the product, the text message alert containing a link to the messaging web page.

3. The system of claim 2, said server receiving a first user text message at the messaging web page from the first user and sending the first user text message to a second user mobile device.

4. The system of claim 3, said server receiving a second user response text message from the second user mobile device, updating the messaging web page with the second user response text message, and sending an updated link to the updated messaging web page to the first user mobile device.

5. The system of claim 4, wherein the text message alert, first user text message and second user response text message are associated with a session ID, and further comprising storing first user response text message and the second user response text message in said database associated with the session ID.

6. The system of claim 1, said server further configured to provide a text message request link at a product web page, the text message request link generating the second user request in response to being selected by the second user.

7. The system of claim 6, wherein said server tags information at the webpage in response to the second user's request.

8. The system of claim 2, said server receiving a responsive message from the first user at the messaging web page in response to the second user request and forwarding the second user responsive message to a first user mobile device.

9. The system of claim 8, said server receiving a responsive text message from the second user mobile device in response to the forwarded message, updating the messaging web page with the responsive text message, and forwarding an updated link to updated messaging web page to the first user mobile device.

10. The system of claim 9, said server storing in said database the second user request, first user responsive text, and second user responsive text.

11. The system of claim 1, wherein the second user request is a text message having a keyword command that is unique to the first user.

12. The system of claim 1, said database further configured to store a first user ID associated with contact information for at least one first user, whereby said server determines the contact information for the at least one first user and forwards the text message alert to the at least one first user mobile device.

13. The system of claim 2, wherein the second user request is entered at the messaging web page by the second user, which is unique to the first user.

14. A text message tethering method for use with a website displaying information about a product, the method comprising:
storing at a database information about the product and a sales agent associated with the product;
receiving at a processor a user request for text messaging information regarding the product, the user request including user information;
determining at the processor the sales agent associated with the product from the database; and
forwarding by the processor a text message alert to the sales agent.
